(19) United States
(12) Patent Application Publication
(10) Pub. No.: US 2022/0412633 A1
(43) Pub. Date: Dec. 29, 2022

(54) MULTI-COMPARTMENT COOLER

(71) Applicant: RAYMOND V. ARDOIN, HUMBLE, TX (US)

(72) Inventor: RAYMOND V. ARDOIN, HUMBLE, TX (US)

(21) Appl. No.: 17/359,458

(22) Filed: Jun. 25, 2021

(51) Int. Cl. F25D 3/08; B62B 1/12; B62B 1/26; B62B 5/06

(52) U.S. Cl. CPC F25D 3/08; B62B 1/125; B62B 1/26; B62B 5/065; B62B 2202/023

(57) ABSTRACT

The multi-compartment cooler includes two cylindrical, thermally insulated containers stacked on top of each other and mounted on a wheeled platform having a telescoping handle. The lower compartment has a spigot for dispensing hot or cold beverages stored in the compartment, and the upper compartment is adapted for storing a transporting packaged foods, such as salads, sandwiches, cold cuts, etc. The cover of the upper compartment may include a hinged lid incorporating a power bank and inductive charging pad for charging the batteries of cell phones, smart watches, tablets, and other electronic devices. The upper and lower compartments may be releasably latched together during transport. The wheeled platform may have two rear wheels and a front caster, or a rigid front cradle.

### BACKGROUND

### 1. Field

The disclosure of the present patent application relates to devices for the storage and transport of food and beverages, and particularly to a multi-compartment cooler having stacked cylindrical compartments mounted on wheels and an inductive charging pad for charging electronic devices.

### 2. Description of the Related Art

When spending a day at the beach, lake, or other outdoor spot, a family or group generally has many items that they wish to take with them to the beach. Such items may include towels, chairs, umbrellas, games, lotions, sunscreen products, food, beverages, and the like. Coolers or thermos bottles are often used to bring along refreshments, including cold drinks or salads and cold cuts that must be kept chilled. However, most coolers do not have separate compartments for carrying a beverage dispenser and packaged foods. Consequently, the user has to carry two separate containers, one for dispensing cold beverages, and one for carrying packaged foods.

Along with those items, people also like to have a collection of electronic devices on hand to make sure that while they are accessible or to further heighten their experience. Such devices could include smartphones, eBooks, tablets, MP3 players, portable speakers, and the like. However, use of those devices would require a proximal power source on hand to charge up the devices when the battery power is depleted. Otherwise, the user would have to return to their vehicle and try and use it to charge their devices, thus saddling the user with periodic and annoying trips to the parking area just to maintain the operability of their electronic devices. Over the course of an extended outdoor stay, this process becomes tedious and diminishes enjoyment of the planned outdoor activity. Thus, a multi-compartment cooler solving the aforementioned problems is desired.

### SUMMARY

The multi-compartment cooler has stacked coolers mounted on a wheeled supporting carrier having a telescoping handle. The wheeled carrier has at least two rear wheels mounted on a common axle, a platform extending forward from the axle, and a central handle base extending upward from the rear of the platform. A telescoping handle with a rearward extending hand grip is mounted in the handle base. The front end of the platform may be supported on a single caster wheel, or may be supported on a rigid cradle. The top of the platform includes a centrally located mounting disk. The lower cooler compartment is a cylindrical, insulated container having a spigot for dispensing a chilled or hot liquid stored in the container, the bottom of the container having a circular recess defined by an annular, downwardly extending flange for slidable mounting on the platform's mounting disk, the top of the container having a circular, upwardly extending cover. The upper cooler compartment is a cylindrical, insulated container adapted for storing packaged foods that must be kept warm or chilled, such as salads, cold cuts, sandwiches, etc. The bottom of the upper cooler container has a circular recess defined by an annular, downwardly extending flange for slidable mounting on the cover of the lower cooler compartment. The upper cooler compartment may be secured to the lower cooler compartment by releasable side latches during transport of the cooler. The top of the upper cooler compartment may have a circular cover having a hinged, rectangular lid mounted thereon. The hinged lid may incorporate a power bank and an inductive charging pad for recharging the batteries of cell phones, smart watches, tablets, and other electronic devices.

These and other features of the present subject matter will become readily apparent upon further review of the following specification.

### BRIEF DESCRIPTION OF THE DRAWINGS

FIG. 1 is a right side view of a multi-compartment cooler.

FIG. 2 is a left side view of the multi-compartment cooler of FIG. 1.

FIG. 3 is a top view of the multi-compartment cooler of FIG. 1.

FIG. 4 is a perspective of the multi-compartment cooler of FIG. 1.

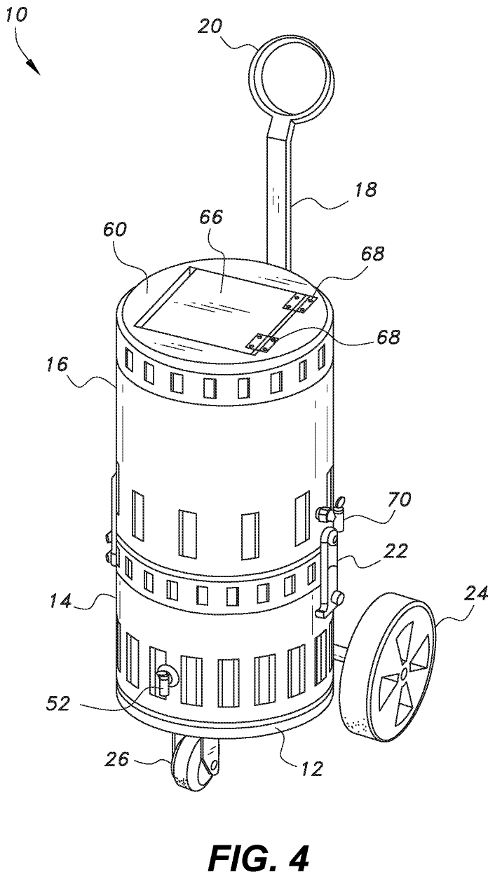

FIG. 5 is a perspective view of a selected components of the multi-compartment cooler of FIG. 1.

Similar reference characters denote corresponding features consistently throughout the attached drawings.

### DETAILED DESCRIPTION OF THE PREFERRED EMBODIMENTS

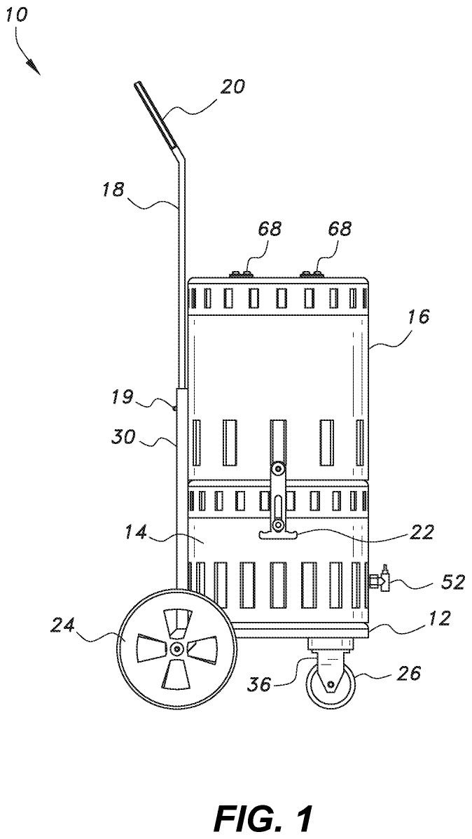

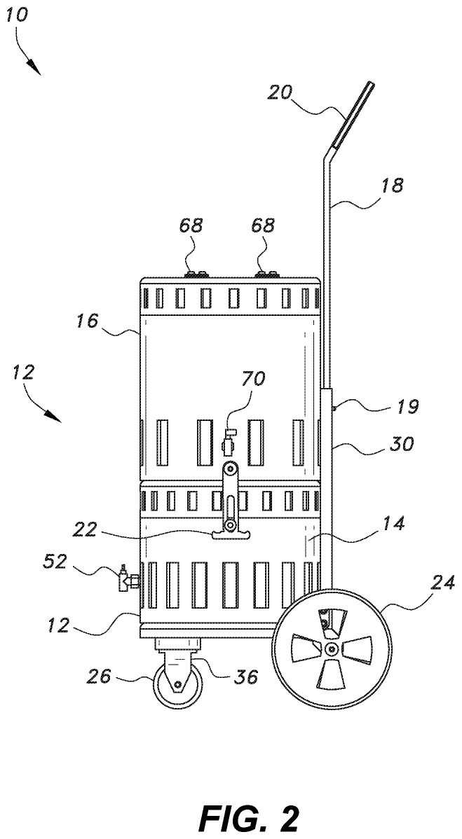

As shown in FIGS. 1 and 2, the multi-compartment cooler 10 includes a wheeled platform 12, a lower thermally insulated compartment 14, an upper thermally insulated compartment 16, a telescoping handle 18 having a rearwardly extending handgrip 20 and a releasable latch 22 securing the upper compartment 16 to the lower compartment 14. The wheeled platform 12 includes at least two wheels, such as rear dolly wheels 24 mounted on a single, common axle. The front of the platform 12 rests on a support structure that keeps the platform 12 level or parallel with a floor, ground surface or other supporting surface when the cooler 10 is at rest. The support structure may be a single caster wheel 26, or may be a rigid cradle.

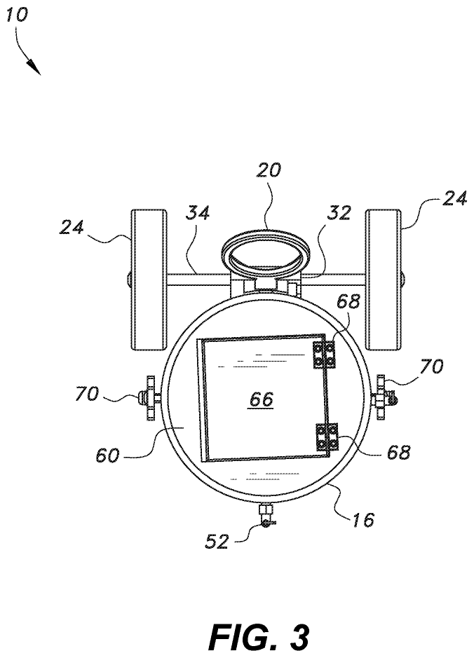

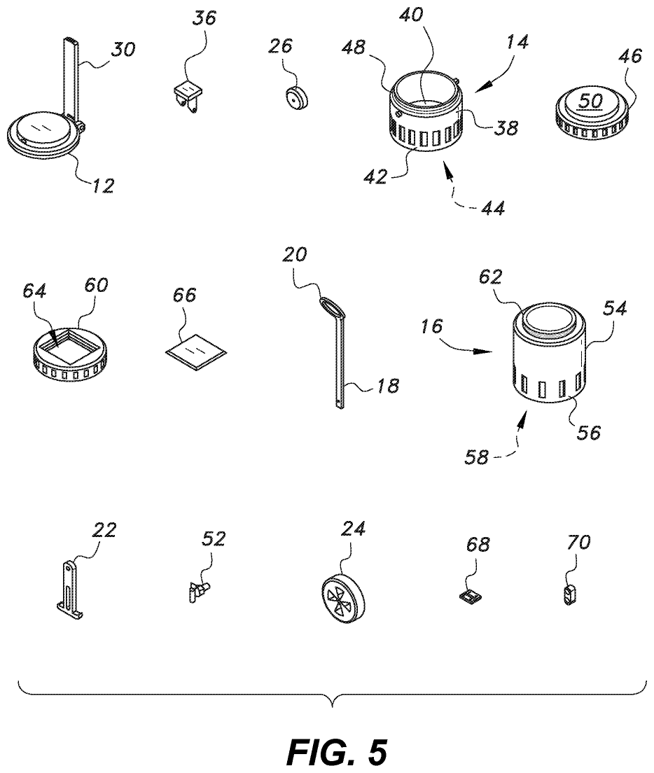

As shown in FIG. 5, the platform 12 includes a centrally located mounting disk 28 mounted on its top surface and a central handle base 30 extending upward from the rear of the platform 12. The telescoping handle 18 having a rearwardly extending handgrip 20 is slidably mounted in the central handle base 30. The height of the handle 18 may be adjusted by a detent pin 19 mounted on the handle 18 that engage apertures defined in the handle base 30, or by any other height adjustment mechanism for telescoping handles known in the art. As shown most clearly in FIG. 3, the platform 12 may further include a tubular sleeve 32 extending rearward from the lower end of the handle base that supports an axle 34 on which the two dolly wheels 24 are mounted. A caster wheel yoke 36 (shown in FIG. 5) may be bolted, welded, or otherwise attached to the bottom surface of the platform 12 at the front end of the platform 12 for mounting the caster wheel 26.

The lower thermally insulated compartment 14 may have a double wall 38 defining a hollow interior adapted for holding a beverage, such as water, coffee, soda, lemonade, etc. The double wall 38 may have foam or other thermal insulation between the inner and outer walls. Alternatively, the compartment 14 may have a silvered glass envelope housed in a metal external wall, the glass envelope being evacuated in the manner of a thermos to prevent gain or loss of heat by heat transfer, thereby keeping hot beverages warm or preventing ice used to cool a beverage from melting. As shown in FIG. 5, the exterior wall of the lower compartment 14 may extend below the floor 40 of the compartment 14 to form a skirt or annular flange 42 defining a circular recess 44 surrounding the central disk 28 on the top surface of the platform 12 so that the lower compartment 14 may be stacked on the platform 12, the flange 42 engaging the disk 28 to prevent the lower compartment from sliding off the platform 12 and so that the lower compartment 14 is slidably and removably mounted on the platform 12. The lower compartment 14 has a cover 46 that may threadably engage the neck 48 at the top of the compartment 14 (or may snap onto the neck 48 to close the compartment 14 or container), the cover 46 having a centrally located disk 50 mounted on its top surface. The lower compartment 14 has a spigot 52 or other liquid dispensing device extending from its outer wall for dispensing a liquid contained therein without removing the cover 46.

The upper compartment 16 also may have a double wall 54 defining a hollow interior adapted for holding packaged foods and beverages, such as salads, cold cuts, sandwiches, bottled or canned beverages, etc. The double wall 54 may have foam or other thermal insulation between the inner and outer walls. Alternatively, the compartment 16 may have a silvered glass envelope housed in a metal external wall, the glass envelope being evacuated in the manner of a thermos to prevent gain or loss of heat by heat transfer, thereby keeping hot foods warm or permitting the use of ice packs to cool foods or beverages. As shown in FIG. 5, the exterior wall of the upper compartment 16 may extend below the floor of the compartment 16 to form a skirt or annular flange 56 defining a circular recess 58 surrounding the central disk 50 on the top surface of the cover 46 of the lower compartment 14 when the upper compartment 16 is stacked on the lower compartment 14, the flange 56 engaging the disk 50 to prevent the upper compartment 16 from sliding off the lower compartment 14. The upper compartment 16 may be further secured to the lower compartment 14 by the releasable latches 22 attached to the exterior of the walls 38, 54 of the respective compartments 14, 16 when the compartments 14, 16 are stacked. The upper compartment 16 may also have grips 70 on one or both sides to assist in lifting the upper compartment or lowering the upper compartment 16 to stack the compartments 14, 16. The upper compartment 16 has a cover 60 that may threadably engage the neck 62 at the top of the compartment 16 (or may snap onto the neck 62 to close the compartment 16 or container).

The cover 60 of the upper compartment 16 may have an opening 64 defined therein. As shown in FIG. 3, the opening 64 may be closed by a lid incorporating a power bank and inductive charging pad 66 attached to the cover 60 by hinges 68, which covers the opening 64. The power bank and inductive charging pad 66 may be used to recharge the batteries of a smart phone, smart watch, tablet, or other electronic device (at least until the pad 66 itself needs recharging) by placing the device on the pad 66. The power bank and inductive charging pad 66 may be, for example, a Qi (an industry standard for wireless charging used by several smart phones) wireless charger.

In use, the lower compartment 14 is filled with a beverage (either hot or cold) and loaded onto the wheels platform 12. The upper compartment 16 is loaded with a packaged food (either warm or chilled), stacked on the lower compartment 14, and secured by the releasable latches 22. The wheeled platform 12 is tilted rearward using the handle 18 and handgrip 20 to support the weight of the cooler 10 on the rear dolly wheels 24 and wheeled to its destination or to a vehicle for transport. After arrival at the destination, the latches 22 may be released and the two compartments 14, 16 may be placed on a table or bench and used independently. The multi-compartment cooler 10 will prove to be of great value on trips to the beach, on picnics, for construction workers, travelers, and other persons when there is no nearby vendor, or when the traveler has special dietary needs.

It is to be understood that the multi-compartment cooler is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A multi-compartment cooler, comprising:
a platform having a front end, a rear end, a top surface, a bottom surface, and a centrally located mounting disk disposed on the top surface of the mounting platform;
a pair of dolly wheels mounted at the rear end of the platform;
a support structure mounted on the bottom surface of the platform at the front end for maintaining the platform level on a support surface when the cooler is at rest;
a telescoping handle extending upward from the rear end of the platform;
a lower compartment removably mounted on the mounting disk on the top surface of the platform, the compartment being cylindrical, thermally insulated, and adapted for containing a beverage, the lower compartment having a removable circular cover;
an upper compartment removably stackable on the lower compartment, the upper compartment being cylindrical, thermally insulated, and adapted for containing packaged foods and beverages, the upper compartment having a removable circular cover having an opening defined therein; and
a lid pivotally attached to the cover of the upper compartment, the lid being pivotal to close the opening in the cover of the upper compartment, the lid having a power bank and inductive charging pad incorporated therein for charging batteries of electronic devices placed on the lid.

2. The multi-compartment cooler according to claim 1, wherein said support structure consists of a single caster wheel mounted on the bottom surface of the platform at the front end of the platform.

3. The multi-compartment cooler according to claim 1, wherein said telescoping handle comprises a handle base rigidly attached to the rear end of the platform and an elongated handle slidably mounted in the handle base, the elongated handle having an upper end and a rearwardly extending handgrip at the upper end, the telescoping handle further having height adjustment means for adjusting extension of the elongated handle from the handle base.

4. The multi-compartment cooler according to claim 3, wherein said height adjustment means includes a detent pin mounted on the elongated handle for selectively engaging the handle base at a desired height.

5. The multi-compartment cooler according to claim 1, wherein said lower compartment has a floor and an outer wall extending below the floor forming an annular flange defining a circular recess receiving the mounting disk on the top surface of said platform, the annular flange closely conforming to the mounting disk to assist in preventing said lower compartment from sliding off said platform.

6. The multi-compartment cooler according to claim 1, wherein said lower compartment further comprises a liquid dispenser extending therefrom for dispensing a beverage from said lower compartment.

7. The multi-compartment cooler according to claim 1, further comprising a releasable latch attached to said lower compartment and said upper compartment for further securing said upper compartment to said lower compartment when said upper compartment is stacked on said lower compartment.

8. The multi-compartment cooler according to claim 1, wherein said upper compartment has an outer wall extending below said upper compartment and forming an annular flange defining a circular recess receiving the circular cover of said lower compartment, the annular flange closely conforming to the circular cover of said lower compartment to assist in preventing said upper compartment from sliding off said lower compartment when said upper compartment is stacked on said lower compartment.

9. The multi-compartment cooler according to claim 1, wherein said power bank and inductive charging pad complies with the Qi wireless charging standard.
